(19) United States
(12) Patent Application Publication
(10) Pub. No.: US 2019/0026106 A1
(43) Pub. Date: Jan. 24, 2019

(54) ASSOCIATING SOFTWARE ISSUE REPORTS WITH CHANGES TO CODE

(71) Applicant: CA, Inc., Islandia, NY (US)

(72) Inventors: Jacob Burton, Islandia, NY (US); Andrew Homeyer, Islandia, NY (US); Kelli Hackethal, Islandia, NY (US); Megan Espeland, Islandia, NY (US); Mary Davis, Islandia, NY (US); Dennis Johnson, Islandia, NY (US)

(21) Appl. No.: 15/655,211

(22) Filed: Jul. 20, 2017

(51) Int. Cl. G06F 9/44; G06F 17/27; G06N 99/00

(52) U.S. Cl. CPC G06F 8/71; G06N 99/005; G06F 17/2785; G06F 8/72

(57) ABSTRACT

Provided is a process of inferring which software-issue reports are addressed by a code-change submission, the process including: obtaining a plurality of software-issue reports; obtaining a current code-change submitted to a repository of source code of a software application; selecting a subset of the software-issue reports by inferring which of the software-issue reports describe an issue addressed by the current code-change; and storing in memory an association between the subset of the software-issue reports and the current code-change.

### BACKGROUND

### 1. Field

The present disclosure relates generally to project management software applications and, more specifically, to inferring which bug reports or feature requests are addressed by a software change.

### 2. Description of the Related Art

Many software-development projects are relatively complex. Often dozens or hundreds of developers or operations engineers contribute to writing and modifying computer code, in many cases, across multiple branching and merging versions of the code, which can run into ten-of-thousands of lines of code in many projects. In many cases, teams use project management applications to track and coordinate their workflows in development tasks, such as a software-development workflow tracking system. Often the number of issues tracked in a software-development workflow tracking system (like a bug tracker) is very large (e.g., in the hundreds or thousands). And often the reported issues are duplicative, overlapping, or are caused by one another.

Determining which of these issues are addressed (e.g., mitigated) by a given code change can be difficult. Developer time and attention is scarce, and overhead associated with updating a workflow tracking system leads to poor tracking of workflow status, which can make planning and managing software development and maintenance difficult. One source of this overhead is associating changes in code with issues submitted by users (or quality-assurance developers or other developers). In many cases, a given change to code may solve or mitigate several issues, and digging those issues out of a large pool of submitted requests can be time consuming, difficult, and unreliable. Existing computer systems for tracking software issue reports are not well suited to address this problem, as many such systems leave it to the developer to search, unaided, within a large pool of software-issue reports for those addressed by a code-change submission.

### SUMMARY

The following is a non-exhaustive listing of some aspects of the present techniques. These and other aspects are described in the following disclosure.

Some aspects include a process of inferring which software-issue reports are addressed by a code-change submission, the process including: obtaining, with one or more processors, a plurality of software-issue reports, each software-issue report having a respective description of a requested change to a software application; after obtaining the plurality of software-issue reports, obtaining, with one or more processors, a current code-change submitted to a repository of source code of the software application; selecting, with one or more processors, a subset of the software-issue reports by inferring which of the software-issue reports describe an issue addressed by the current code-change, wherein selecting the subset of the software-issue reports comprises: extracting code-change features of the current code-change submitted to the repository, applying the code-change features to a model trained on a training set including labeled training records, each labeled training record including features of a previous code-change and a software-issue report addressed by the previous code-change, determining scores with the model indicative of likelihoods that corresponding respective software-issue reports describe an issue addressed by the current code-change, and selecting the subset of the software-issue reports based on the scores; and storing, with one or more processors, in memory an association between the subset of the software-issue reports and the current code-change.

Some aspects include a tangible, non-transitory, machine-readable medium storing instructions that when executed by a data processing apparatus cause the data processing apparatus to perform operations including the above-mentioned process.

Some aspects include a system, including: one or more processors; and memory storing instructions that when executed by the processors cause the processors to effectuate operations of the above-mentioned process.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 shows a project management computer system in accordance with some embodiments;

FIG. 2 shows an example of a process to match code-change submissions to software issue reports in accordance with some embodiments;

FIG. 3 shows an example of a process to train and use a model that may be used in the process of FIG. 2 in accordance with some embodiments;

FIG. 4 shows an example of a process to train and use another model that may be used in the process of FIG. 2 in some embodiments;

FIG. 5 shows an example of a user interface of the project management computer system in accordance with some embodiments of the present techniques; and

FIG. 6 shows an example of a computer system by which the above techniques may be implemented in some embodiments.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION OF CERTAIN EMBODIMENTS

To mitigate the problems described herein, the inventors had to both invent solutions and, in some cases just as importantly, recognize problems overlooked (or not yet foreseen) by others in the fields of computer science, natural-language processing, and software-development tooling. Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

Some embodiments train and use a supervised natural language processing machine learning model to infer which reported software issues are likely related to a change in code being committed to a repository. In some cases, the developer may be presented with a list of ranked candidate issues inferred by the model, and the developer may select among this list to designate which are addressed by the change to the code. In some cases, each of those issues may then be advanced through a workflow (e.g., for instance, to be reviewed by a quality-assurance engineer or supervisor before being cleared and released) and, in some cases, each of the designated issues may be associated with the commit and the code that was changed in memory. In some cases, user-interfaces relating to the designated issues may be augmented with links to the commit and the code.

In some embodiments, the training set may include previously logged changes to code and manual designations of related issues by developers. In some cases, the training set may span tenants of a multi-tenant software-as-a-service project management computer system, and in some cases, the training set may be segmented by code library or framework being changed, called, calling the changed code, or otherwise invoked. Segments-specific models may be trained in some cases. Or some embodiments may train models without regard to such segments, e.g., for newly developed code that does not have a history of changes in a training set.

The model may take many forms, including various forms of natural language processing models. In some cases, the model may be a machine learning model that avoids or mitigates some of the brittleness of expert systems based on predefined, hand-coded matching rules, though embodiments may combine these approaches, e.g., by selecting with hand coded rules code-segment specific models that implement machine learning techniques. Some embodiments may group text of issues in the training set with text of code changed when addressing those issues in the training set to form a plurality of records. Some embodiments may train a Latent Semantic Analysis (LSA) model on the n-grams in those records. Later, when new code changes and issues are obtained, the code changes and new issues may be paired based on Euclidian distance, cosine distance, or Minkowski distance in a vector space defined by the LSA model (e.g. if a code change is semantically similar to a previous record X and an issue is also similar, then they may be designated as paired or assigned a score indicative of the strength of the pairing for ranking candidates). In another example, training set records of issues and code changes may be grouped with an unsupervised topic model, like Latent Dirichlet allocation. Later, code changes and issues that map to the same topics produced by this model may be presented as candidates when new code changes are encountered. Or embodiments may implement other natural language processing models described below.

The data model may take a variety of forms described below. Software-issue reports may include a variety of text fields within which features may be detected, including titles, descriptions, comments, labels, and milestones. Code similarly may be based on a variety of text fields, including libraries and frameworks invoked and the code itself, along with before and after versions of the code. Some embodiments may build a model that predicts the likelihood of n-grams in an issue occurring given n-grams in code based on pairs of code changes and issues in the training set. In some cases, these likelihoods may be weighted with term-frequency inverse document frequency (TF-IDF) scores, like BM25 or the like. Later, when new code changes are received, issues may be ranked according to aggregate measures of these weighed probabilities corresponding to n-grams in the issues.

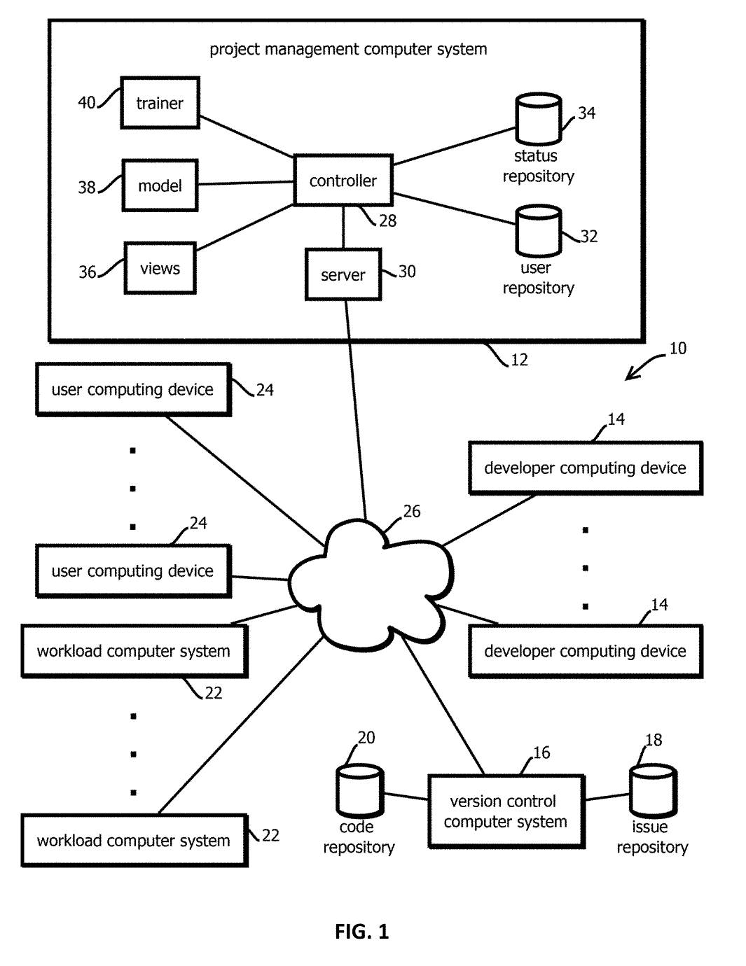

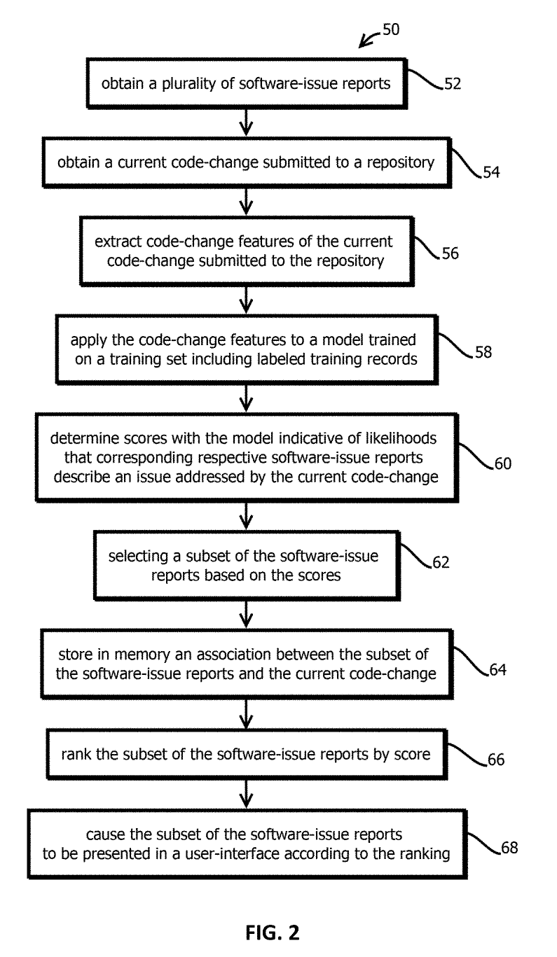

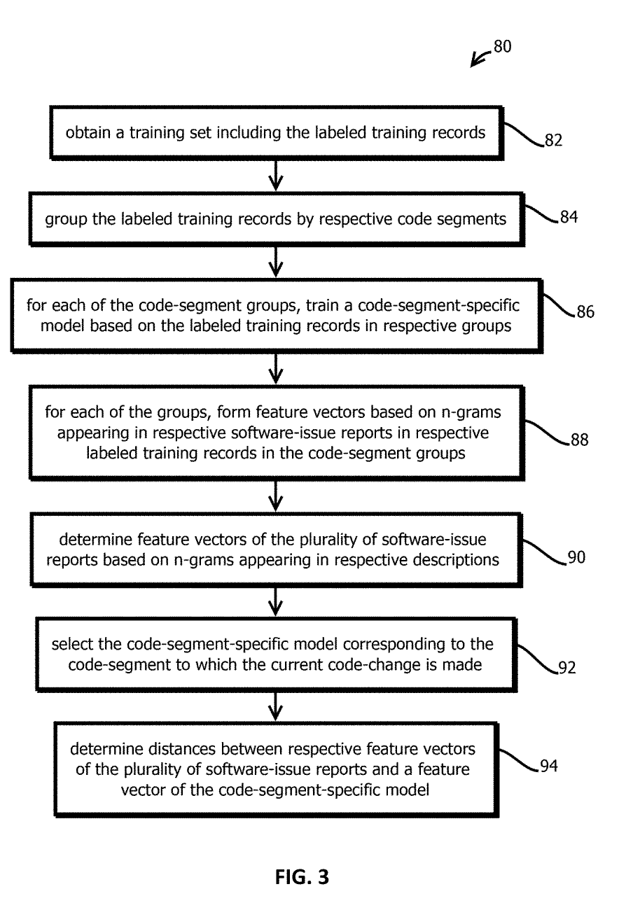

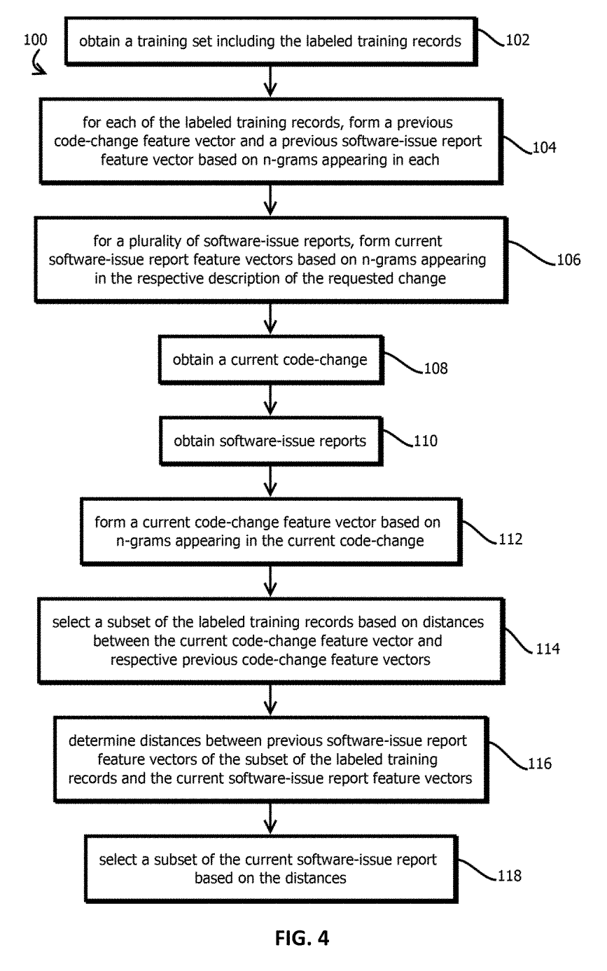

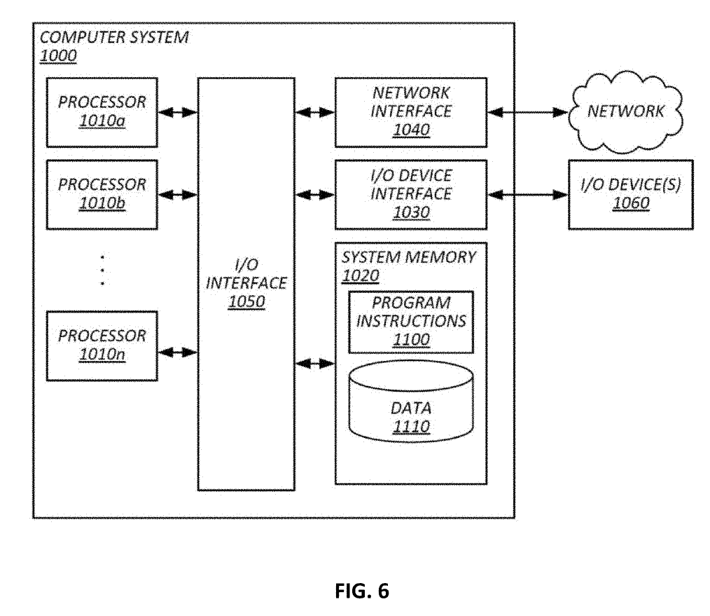

In some embodiments, these and other techniques may be implemented in a computing environment 10 (including each of the illustrated components) shown in FIG. 1 having the illustrated project management computer system 12. The project management computer system 12 may be configured to track the status of software-related projects (and other projects) and facilitate software-issue report tracking in relation to those projects by implementing techniques like those described above. In some embodiments, this project management computer system 12 may execute a process described below with reference to FIG. 2 to infer which software-issue reports correspond to a given code-change submission with a trained model for making such inferences. In some embodiments, the model may be trained and used with processes described below with reference to FIGS. 3 and 4. In some embodiments, these techniques may be implemented on a collection of computers like the computer system (also referred to as a computing device in cases in which the system has one computer) described below with reference to FIG. 6.

In some embodiments, the computing environment 10 includes a plurality of developer computing devices 14, a version control computer system 16 having an issue repository 18 and a code repository 20, a plurality of workload computer systems 22, and a plurality of computing devices 24. In some cases, the computer systems may be a single computing device or a plurality of computing devices, for instance, executing in a public or private cloud. In some embodiments, these computing devices may communicate with one another through various networks, such as the Internet 26 and various local area networks.

In some embodiments, the developer computing devices 14 may be operated by developers that write and manage software applications. In some cases, source code for the software applications may be stored in the version control computer system 16, for instance, in the code repository 20. In some cases, this code may be executed on the workload computer systems 22, and in some cases, user computing devices 24 may access these applications, for instance, with a web browser or native application via the Internet 26 by communicating with the workload computer systems 22. In some embodiments, the computing environment 10 and the project management computer system 12 are multi-tenant environments in which a plurality of different software applications operated by a plurality of different entities are executing to serve a plurality of different groups of user computing devices 24. In some cases, groups of developer computing devices 14 may be associated with these entity accounts, for instance, in the version control computer system 16 and the project management computer system 12, such that developers associated with those accounts may selectively access code and projects in these respective systems.

In some embodiments, the version control computer system 16 having the repositories 18 and 20 is a Git version control system, such as GitHub™, Bitbucket™, or GitLab™. Or embodiments are consistent with other types of version control systems, including Concurrent Versions System™, or Subversion™. In some cases, the version control computer system 16 includes a plurality of different version histories of a plurality of different software applications in the code repository 20. In some embodiments, the version control computer system 16 may organize those records in an acyclic directed graph structure, for instance, with branches indicating offshoots in which versions are subject to testing. In some cases, these offshoots may be merged back into a mainline version. In some embodiments, some versions may be designated as production versions or development versions. In some embodiments, the source code in each version may include a plurality of subroutines, such as methods or functions that call one another, as well as references to various dependencies, like libraries or frameworks that are called by, or that call, these subroutines. In some cases, a given version of software may be characterized by a call graph indicating which subroutines call which other subroutines or libraries or frameworks. In some cases, the source code may include various reserved terms in a programming language as well as tokens in a namespace managed by the developer or a developer of libraries or frameworks. These reserve terms may include variable names and names of subroutines in the source code, libraries, or frameworks that are called. Some embodiments may leverage the resulting namespaces to match software-issue reports to code changes.

In some embodiments, the version control computer system 16 may further include an issue repository 18. In some cases, developers, through developer computing devices 14 or users through user computing devices 24 may submit software-issue reports indicating problems with software or requested features for software executing on the workload computer systems 22. In some embodiments, each resulting software-issue report may include a description of the issue, for instance in prose, entered by a user or developer describing the problem. In some cases, the description may be in a human-readable, non-structured format and may range in length from three words up to several hundred or several thousand words or more.

In some cases, the software-issue reports may also include structured data, for instance, based on check boxes, radio buttons, or drop-down menu selections by a user or developer submitting a software-issue report via a user interface that the version control system 16 or project management computer system 12 causes to be presented on their respective computing device. In some cases, these values may indicate severity of an issue, whether the issue is a request for a new feature or a request to fix a problem, values indicating a type of the problem, like whether it relates to security, slow responses, or problems arising in a particular computing environment. In some cases, the request may also include a description of the computing device upon which the problem is experienced, like a manufacturer, operating system, operating system version, firmware versions, driver versions, or a geolocation of the computing device. In some cases, the report further includes timestamp indicating when the software-issue report was submitted and an identifier of a software application to which the report pertains, such as one of the software applications associated with a version history in the code repository 20 and an application executing on some of the workload computer systems 22. In some cases, each software application may include an application identifier used by the version control system to identify that software application in the code repository 20 and the issue repository 18.

In some embodiments, the version control system 16 may also maintain accounts associated with different entities authorized to access source code associated with each of a plurality of different applications and roles and permissions of developers associated with respective credentials by which developers associated with those entities make changes to the source code. In some embodiments, developers may submit changes to source code in the code repository 20, for instance, with a “commit” in some embodiments, each commit may be associated with a timestamp, a unique identifier of the commit, an application, and a branch and location in a branch in a version history of the application in the code repository 20. In some embodiments, the commits may be encoded as differences between a current version in the respective branch and the committed version, for instance, identifying code that is deleted and identifying code that is added as well as including the deletions and additions. In some cases, this may be characterized as a “diff” relative to the existing code in the most current version of a branch to which the changes submitted.

In some embodiments, the submission may be made by the developer computing devices 14 directly to the version control computer system 16, and the version control system 16 may emit an event indicative of the submission to the project management computer system 12, which may execute an event handler configured to initiate the described responsive actions. Or in some cases, the submissions may be sent by the developer computing devices 12 to the project management system 12, which may then send the changes to the version control computer system 16. Or the version control computer system 16 or the repositories 18 or 20 may be integrated with the project management computer system 12.

In some embodiments, the project management computer system 12 is configured to track the status of a plurality of different projects for a plurality of different tenants. In some cases, the projects relate to development and maintenance of the software applications described above. In some cases, the project management computer system 12 is further configured to manage and track workflows by which these projects are implemented and maintained, for instance, routing tasks from one user to another user, such as a developer users or operations engineer users, as a given project is advanced through a series of tasks in the project. Further, in some cases, the project management computer system 12 is configured to form and cause the presentation of various dashboards and displays indicative of the status of the projects and task queues of respective users having tasks assigned to them, their group, or to someone in their role. Corresponding records may be created, updated, and accessed by the project management computer system 12 in memory to effectuate this functionality.

To these ends or others, in some embodiments, the project management computer system 12 includes a controller 28, a server 30, a user repository 32, a status repository 34, a view generator 36, an inference model 38, and a trainer 40. In some embodiments, the controller 28 may execute the processes described below with reference to FIGS. 2 through 4 and coordinate the operation of the components of the project management computer system 12.

In some embodiments, the server 30 may monitor a network socket, such as a port and Internet protocol address of the project management computer system 12, and mediate exchanges between the controller 28 and the network 26. In some embodiments, the server 30 is a nonblocking server configured to service a relatively large number of concurrent sessions with developer computing devices 14, such as more than 100 or more than 1000 concurrent sessions. In some embodiments, multiple instances of the server 30 may be disposed behind a reverse proxy configured to operate as a load balancer, for instance, by allocating workload to different instances of the server 30 according to a hash value of a session identifier.

In some embodiments, the user repository 32 includes records identifying users of the project management computer system 12. In some cases, this may include a tenant record listing a plurality of user records and roles and permissions of those users. In some embodiments, each user record may indicate credentials of the user, a unique identifier of the user, a role of the user, and configuration preferences of the user. In some cases, the number of users may be more than 100,000 users for more than 10,000 tenants.

In some embodiments, the status repository 34 may include a plurality of project records, each project record corresponding to a project for which status is tracked. In some embodiments, the project records may include a workflow, a current status in the workflow, and tasks associated with various stages of the workflow. In some cases, the tasks may be arranged sequentially or concurrently, indicating whether one task blocks a subsequent task. In some cases, the tasks may be associated with respective roles indicating a person or role of people to whom the task is to be assigned, in some cases referencing records in the user repository 32. In some embodiments, as users progress through tasks, the project management computer system 12 may receive updates from users interacting with user interfaces of the project management computer system presented on remote computing devices of the users. The status repository records may be updated to reflect the reported changes, e.g., that a task is complete, a new project is initiated, or the like.

In some cases, a sequence of tasks may be generated by controller 28 responsive to submission by a computing device 14 or 24 of a software-issue report stored in the issue repository 18. For example, such a project may include a triage task to evaluate whether the software-issue report is valid or has already been addressed, a diagnostic task, a code-change task by which the change is implemented, a quality assurance task by which the submission is tested, and a release task by which code implementing the change is released to a test environment, and a full release task by which the code change is released in a non-test, production version of the corresponding application. In some embodiments, different users (e.g., in virtue of having a role or being in a group) may be assigned different ones of these different tasks, and the status of each software-issue report through such a workflow may be tracked. In some cases, different tenants or applications may have associated therewith in memory of the system 12 a template defining such a workflow, and different workflows may be managed by controller 28 based on such templates.

In some cases, issue submissions, such as software-issue reports may be sent by users or developers to the version control computer system 16, which may emit an event to the project management computer system 12 containing a description, such as the full record, of the report, or in some cases, software-issue reports may be submitted to the project management computer system 12, which in some cases, may house the issue repository 18. In some embodiments, each of the version control computer system and code repositories 20 may also be integrated with the project management computer system 12.

In some embodiments, the view generator 36 may be configured to generate various user interfaces by which users view the status of their projects, dashboards, a task queues, as well as create new workflows and projects. In some cases, these views may include a queue of tasks for a given user, a queue of tasks for a group of users in a role, a queue of tasks for a project, or the like. In some cases, these views may further include a graphical representation of the status of a given project through a workflow, for instance, indicating which tasks has been performed, which tasks remain to be performed, and which tasks are serving as blocking tasks for other sequential tasks. In some embodiments, these views may be presented on developer computing devices 14. In some embodiments, the project management computer system 12 is configured to cause presentation of these views by sending instructions to the developer computing devices 14 to render the views (e.g., with webpage markup and scripting rendered in a client-side browser). Or in some cases, the project management computer system 12 may be executed by one of the developer computer systems 14, and causing presentation may include instructing the same computing device to present the view. In some embodiments, the views may be encoded as dynamic webpages, for instance, in hypertext markup language and include various scripts responsive to user inputs and configured to send data indicative of those inputs to the project management computer system 12.

In some embodiments, the inference model 38 is configured to receive source-code change submissions, such as Git commits and infer which of the software-issue reports are likely (e.g., relatively likely as determined by a machine learning model) addressed by (e.g., describe a problem or need mitigated by) the code-change submission. In some embodiments, the model 38 is a trained supervised machine learning natural language processing model like those described below with reference to FIGS. 2 through 4. In some embodiments, the model is an unsupervised machine learning natural language processing model. In some embodiments, the model 38 is configured to infer which software-issue reports are likely addressed by a given code-change submission based on n-grams, such as sequences of one, two, three, four, five, or more or fewer sequential tokens, like words, appearing in descriptions of software-issue reports or source code.

In some embodiments, inferences may be made based on subroutines that are changed, like an identifier of a subroutine, or based upon adjacent subroutines in a call graph of a software application. Some embodiments may recursively traverse the call graph, for instance, with a depth first or breadth first traversal from a subroutine to which a change is made to identify adjacent subroutines and further subroutines, for instance, two, three, or four (or some other threshold number of) calls away from a subroutine to which a submission is made.

Thus, some embodiments of the model 38 may receive a code-change submission, extract features from the code-change submission (e.g., identifying n-grams, name-space defined tokens, program structure, and the like), and input the extracted features to the model 38, and output a set of software-issue reports in the issue repository 18 inferred to be potentially addressed by the code-change submission. In some cases, this operation may be a relatively latency-sensitive operation. In some embodiments, the model may output a set of candidates, and a developer may select among those candidate software-issue reports to identify those addressed by a code-change submission. In some cases, developers may be unwilling or prefer not to wait more than five seconds, and in many cases not more than 500 ms, before receiving this candidate set of lists of software-issue reports to select among. Accordingly, some embodiments may train the model 38 in advance of a given inference performed by the model, for instance, with a daily, weekly, or monthly training processes described below to expedite operations. In some embodiments, model training may be performed by the trainer module 40 executing the processes described below.

In some embodiments, to train and use a model, the project management computer system 12 may execute a process 50 shown in FIG. 2, though embodiments of the process are not limited to that implementation, which is not to suggest that any other feature is limited to the arrangement described. In some embodiments, the operations of the process 50 may be performed in a different order from that illustrated, in some cases, in multiple repetitions, and in some cases with some steps omitted, again which is not to suggest that other embodiments are limited to the described arrangement. In some embodiments, the process 50 may include obtaining a plurality of software-issue reports, as indicated by block 52. In some cases, the software issue reports may be bug reports or feature requests submitted by users or developers and stored in the issue repository 18 described above. In some cases, a relatively large number of software-issue reports may accumulate over relatively long duration of time for a given application, for instance, more than 1000, more than 10,000, and in many commercially relevant use cases more than 100,000, accumulated over a trailing week, month, or year, or more. Software issue reports may be designated as open, in progress, or closed, based upon a status of corresponding projects in the project management computer system 12. In some embodiments, each software-issue report may correspond to a respective project, or in some embodiments, groups of software issue reports may be grouped as corresponding to a single project. In some cases, software issue reports may be paired with the project in virtue of selections made based upon candidates suggested by the above-describe machine-learning model, for instance, in the course of submitting a change to source code.

Accordingly, some embodiments may include obtaining a current code change submitted to a repository, as indicated by block 54. In some cases, this may include obtaining Git commits identifying an application, a version of the application to which the code change submission is made, and a developer submitting the code change. As noted above, in some cases, code changes may be routed through the project management computer system 12 or the version control computer system 16 may emit events to the project management computer system 12 responsive to such submissions, and the project management computer system 12 may retrieve the code-change submission via an application program interface of the version control computer system 16 in response to the event.

Next, some embodiments may extract code-change features of the current code-change submitted to the repository, as indicated by block 56. In some cases, this may include identifying (e.g., parsing text and detecting) subroutines that are modified by the code-change submission, identifying reserved terms in the code-change submissions (like deleted reserve terms or added reserve terms), identifying namespace tokens (like variable names or subroutine names, added or deleted from source code), and identifying n-grams in source code comments added or deleted. In some cases, extracted features include references to tokens and name spaces of libraries or frameworks in the code-change submission. In some cases, extracting features includes forming a feature vector, for instance a vector including a dimension for each subroutine in the application or each library or framework in the application. In some cases, the feature vector includes dimensions corresponding to each n-gram appearing in a namespace of the application or each n-gram that is a reserved term. Feature vectors need not be referred to as vectors in source code to constitute a feature vector and other data structures that encode the same information may also serve as feature vectors even if labeled differently, for example, as tuples, or objects having a collection of attributes. Further, feature vectors may be encoded in other data structures, like hierarchical arrangements of data while still constituting feature vectors.

Next, some embodiments may apply the code-change features to a model trained on a training set including labeled training records, as indicated by block 58. In some embodiments, labeled training records may be obtained from previous code-change submissions that were manually matched to software-issue reports by developers, for instance, over a trailing month, year, or since the development of the application or operation of the project management computer system 12 began. In some cases, some of the training records may be older than one day, one month, or one year relative to when the current-code change submission was received. In some embodiments, each training record may include the code-change submission of that training record (such as a feature vector of that code-change submission), and a set of software-issue reports (such as feature vectors of the software issue reports) that were designated by the developer as having been addressed by the code-change submission. In some cases, the number of training records may be relatively large, such as more than 1000, more than 10,000, and in many cases, more than 100,000.

Next, some embodiments may determine scores with the model indicative of likelihoods that corresponding respective software-issue reports describe an issue addressed by the current code-change, as indicated by block 60. “Likelihood” here refers to relative inferred relationship strengths and does not require some absolute measure of probability. In some cases, the model may be configured to output binary scores indicative of whether a given software issue report potentially pertains to the code-change submission, or in some cases, the scores may indicate a strength of correspondence, like a value between zero and one or a value between zero and ten.

Next, some embodiments may select a subset of the software-issue reports based on the scores, as indicated by block 62. In some cases, this may include filtering out software-issue reports having less than a threshold score. In some cases, this may include ranking the software-issue reports and selecting those having higher than a threshold rank, with higher values indicating stronger correspondence. (Or these techniques may be applied with signs reversed to the same ends, as is true of other threshold comparisons herein.) In some embodiments, determining scores includes identifying a universe of open software-issue reports pertaining to an application to which the code-change is submitted and determining scores for those open software-issue reports for that software application.

Some embodiments may then store in memory an association between the subset of the software-issue reports and the current code-change, as indicated by block 64. In some cases, this may be done by designating in program state a list of candidate software-issue reports.

Some embodiments may rank the subset of the software-issue reports by the score, as indicated by block 66, and cause the subset of the software-issue reports to be presented in a user interface according to the ranking, as indicated by block 68. In some cases, this may include sending instructions to a developer computing device to present a user interface having an ordered ranking of the candidate software-issue reports, each software-issue report being presented in association with a user input by which the developer may designate the candidate software-issue report as pertaining to the code-change submission. The user interface may be configured to report selections to the project management computer system. In some cases, these designations may be added to the labeled training set for future updated training of the model. As a result, some embodiments may substantially lower the burden associated with identifying software-issue reports addressed by code changes for developers, though embodiments are not limited to systems providing this benefit, as various other use cases and tradeoffs are envisioned, which is not to suggest that any other description is limiting.

FIG. 3 shows an example of a process 80 by which a model is trained and used to select candidate software-issue reports responsive to a code-change submission. In some embodiments, these operations may be performed in a different order, replicated, or omitted, again which is not to suggest that any other feature is limited to the arrangement described. In some embodiments, the process 80 may be performed by the model 38 and trainer 40 described above.

Some embodiments include obtaining a training set including labeled training records, as indicated by block 82. This may include the operations described above in association with block 58. Next, some embodiments may group the labeled training record by respective code segments, as indicated by block 84. In some cases, this may include grouping the training records by the subroutine to which code changes are made. In some cases, this may include grouping the training records by subroutines adjacent a subroutine to which a change is made in a call graph. In some cases, grouping may be based on a directory in which the source code is stored in a code repository. In some cases, grouping may be based on keywords appearing in the code segments, such as based on code segments referencing a network socket, code segments referencing a view, or code segments referencing a database. In some embodiments, grouping may be based on topic inferred with a topic mode (e.g., an LDA topic model) trained on source code.

Next, for each of the code-segment groups, some embodiments may train a code-sub-segment-specific model based on the labeled training records in the respective groups, as indicated by block 86. In some cases, this may include identifying, in each group, in some cases, the software-issue reports paired with code-change submissions in the respective group. In some cases, this may include forming a feature vector based on n-grams, or the other structured metadata described above, in the software-issue reports in the respective group. In some cases, the feature vectors may include a dimension corresponding to each n-gram in a corpus of all of the software-issue reports. In some cases, dimensions of the feature vector may have a value indicative of a relative frequency of the respective n-gram in the software-issue reports in the group relative to frequency of occurrence of the n-gram in other groups (e.g., all groups, or a larger set of groups). For example, some embodiments may determine a TF-IDF score of the respective n-grams of the respective dimensions for each dimension of the feature vector. In some cases, this may include the number of times that the respective n-gram occurs in descriptions of bugs in the software-issue reports in the respective group, divided by the number of times that the n-gram appears in software-issue reports for all of the groups. Or in some cases, these values may be normalized by a size of the respective issue reports, for instance, dividing the number of times the n-gram occurs by the total number of instances of n-gram of that size in the respective software-issue report.

Next, some embodiments may preprocess the open software-issue reports to expedite inferences at query time. To this end, some embodiments may determine feature vectors of the plurality of open software-issue reports based on n-grams appearing in the respective descriptions, as indicated by block 90. In some cases, these feature vectors may be determined with the techniques described above with reference to block 88. For instance, the feature vectors may be based on a TF-IDF score for each n-gram appearing in a corpus that occurs in the respective software-issue report. In some cases, the feature vectors may have more than 100, more than 1000, or more than 10,000 dimensions, with each dimension corresponding to a respective n-gram. In some cases, the value of the respective dimension may indicate the relative frequency of the respective n-gram in the document of the software-issue report relative to the frequency of the respective n-gram in all software-issue reports for the application or for a plurality of applications (in some cases across records for different tenants).

Next, some embodiments may select the code-segment-specific model corresponding to the code-segment to which the current code-change is made, as indicated by block 92. In some cases, this operation may be performed at query time, upon receiving the current code-change submission and before presenting candidate software-issue reports for the developer to select among.

Next, some embodiments may determine distances between respective feature vectors of the plurality of software-issue reports and a feature vector of the code-segment-specific model, as indicated by block 94. In some cases, this operation may be expedited by preprocessing the feature vectors of the open software-issue reports in block 90, though embodiments are not limited to systems that afford this benefit, which is not to suggest that other embodiments are limited to the arrangement described. In some cases, distances may be determined based on angles between the feature vectors, such as cosine angular distances. In some cases, distances are based on Euclidean distances in the feature vector spaces or are based on Minkowski distances. Thus, some embodiments may determine a distance for each of the open software-issue reports relative to the feature vectors for software-issue reports in the training set of the code-segment-specific group in block 86. In some cases, these distances may serve as the above-describe score in block 60, 66, and 68.

Alternatively, or additionally, some embodiments of a process 100 in FIG. 4 may select candidate software-issue reports independently of the subroutines that are changed, for instance, when processing changes to a new subroutine having less than a threshold amount of previous changes in a labeled training set. Some embodiments include obtaining a training set including the labeled training records, as indicated by block 102. Some embodiments include, for each of the labeled training records, forming a previous code-change feature vector and a previous software-issue report feature vector based on n-grams appearing in each of the previous code change and the previous software-issue reports paired with that code change in the training records, as indicated by block 104. Thus, some embodiments may form two feature vectors for each training record and may maintain an association between those two feature vectors for subsequent operations.

Next, for a plurality of software-issue reports, some embodiments may form current software-issue report feature vectors based on n-grams appearing in the respective description of the requested change, as indicated by block 106. In some cases, this may include identifying open software-issue reports and forming the current software-issue report feature vectors for those reports. In some cases, this may include preprocessing the software-issue reports in advance of a query time inference. This may expedite subsequent operations to relatively quickly provide a developer a list of candidate software issue reports to select among upon a code-change submission. Though, again, embodiments are not limited to systems that provide this benefit, which again is not to suggest that other descriptions are limiting.

Next, some embodiments may obtain a current code change, as indicated by block 108, and obtain software-issue reports, as indicated by block 110. In some cases, the obtained software-issue reports may include those preprocessed in block 106 and additional new software-issue reports. Some embodiments may identify the new, un-preprocessed software-issue reports and form feature vectors for those new software-issue reports.

Next, some embodiments may form a current code-change feature vector based on n-grams appearing in the current code-change, as indicated by block 112. In some cases, these feature vectors may be like those described above with reference to FIGS. 2 and 3.

Next, some embodiments may select a subset of the labeled training records based on distances between the current code-change feature vector and respective previous code-change feature vectors, as indicated by block 114. In some cases, these distances may be cosine angular distances based on angles between the respective pairs of feature vectors. In some cases, the previous code-change feature vectors may be those related to other applications than that to which a current code change is submitted. In some cases, this is expected to facilitate relatively fast selection at query time when identifying candidate software-issue reports to present to a developer after a code-change submission, though again embodiments are not limited to systems affording this benefit, which again is not to suggest that other features described are limiting.

Next, some embodiments may determine similarity between the text of the software-issue reports in the selected subset of labeled training records and text of open software-issue reports. To this end, some embodiments may determine distances between the previous software-issue report feature vectors of the subset of the labeled training records and the current software-issue report feature vectors, as indicated by block 116. Again, these distances may be cosine angular distances based on angles between the vectors, Euclidean distances or Michalski distances or the like.

Next, some embodiments may select a subset of the current (e.g., open) software-issue reports based on the distances, as indicated by block 118. In some cases, these distances may serve as the scores described above in blocks 60, 62, and 66. Some embodiments may select those having less than a threshold distance, those above a threshold rank based on which have the smallest distance, or the like. The resulting subset of software-issue reports may be presented to a developer in accordance with the techniques described above with reference to FIGS. 1 and 2 to confirm the selection and expedite developer efforts to identify and close software-issue reports after submitting a code change.

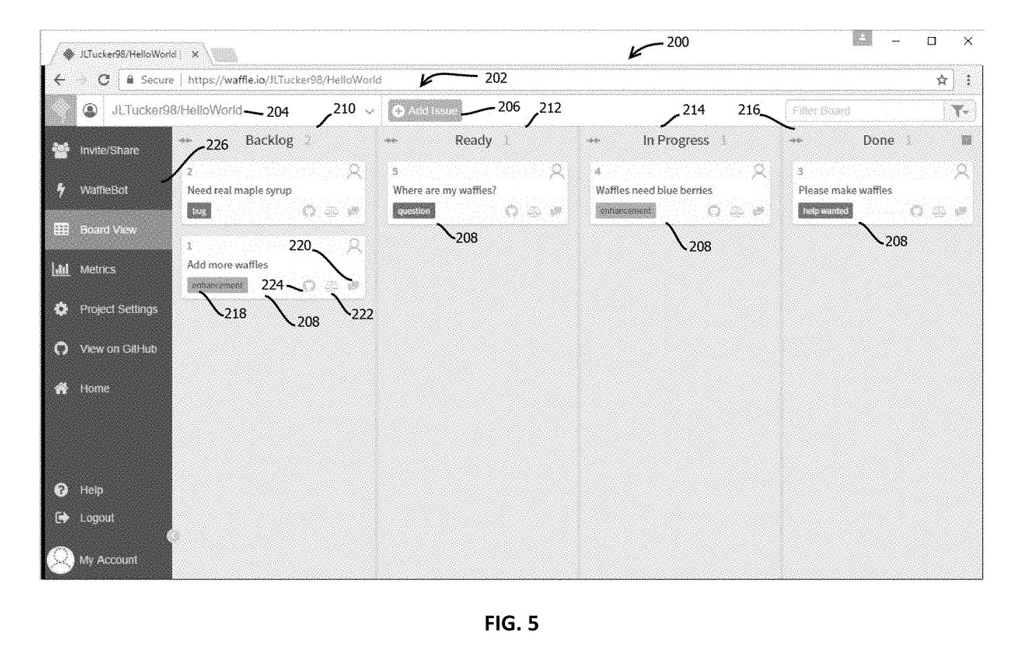

FIG. 5 shows an example of a user interface that may include data output by, or gathered for, the above-described techniques. In some embodiments, the user interface 200 may be displayed within a web browser, for instance, on a developer computing device logged into an account with the above-described project management computer system, which may send markup instructions and scripts by which the user interface is rendered and operated. In some embodiments, the user interface 200 may include a task board 200 that displays a plurality of tasks in one or more workflows. In some embodiments, the workflows may have a single task, or in some cases the workflows may have a plurality of tasks. In some embodiments, the task board 202 may display tasks relating to a project 204, and a given user may be associated with a plurality of different projects, for example, with the above-described version control system. In some cases, a plurality of users may be associated with a single project, and the task board may display the result of a query executed by the project management computer system that filters tasks by user, by project, by team, or by software issue report.

In some embodiments, the user interface 200 may include a user input 206 by which a user may add a software-issue report or task to the project 204. In some cases, upon selecting the interface 206, a set of user inputs may be displayed by which a user may enter a title of an issue, a description of the issue, a type of the issue, and assign the issue to another user or themselves. This information may be reported by the user interface 200 back to the project management computer system, which may update corresponding records.

In some embodiments, the task board 202 may include a plurality of task cards 208, also referred to as work items. In some cases, each task card 208 may correspond to a task in a workflow or a workflow. In some embodiments, task cards 208 may correspond to issue reports. In some embodiments, the user interface 200 includes event handlers operative to detect and onclick (or ontouch) event on a given one of the task cards 208 and display an animated movement of the task card following a user's cursor until a clickrelease (touchrelease) event is detected, at which point some embodiments may respond by dropping the task card in a closest column 210, 212, 214, or 216, indicative of a status of the task card, for instance, indicating progression of the task towards being completed. In some embodiments, data indicative of these movements may be reported by the user interface 200 back to the project management computer system, which may update corresponding records.

In some embodiments, each task card 208 may indicate a title and a category of the task (e.g. a bug fix, an enhancement, answering a question, or the like) 218, and include a user input to 220 by which a user may add comments to the task, a user input 222 by which a user may assign a score to the task indicative of the size of the task, and a user input 224 by which a user may navigate to a user interface in the version control system described above, for instance, having source code by which changes may be made to address the corresponding task. In some embodiments, the user interface 200 may further include a user input 226 by which a user may navigate to a configuration display by which a user may configure the various algorithms described above.

FIG. 6 is a diagram that illustrates an exemplary computing system 1000 in accordance with embodiments of the present technique. Various portions of systems and methods described herein, may include or be executed on one or more computer systems similar to computing system 1000. Further, processes and modules described herein may be executed by one or more processing systems similar to that of computing system 1000.

Computing system 1000 may include one or more processors (e.g., processors 1010a-1010n) coupled to system memory 1020, an input/output I/O device interface 1030, and a network interface 1040 via an input/output (I/O) interface 1050. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1000. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1020). Computing system 1000 may be a uni-processor system including one processor (e.g., processor 1010a), or a multi-processor system including any number of suitable processors (e.g., 1010a-1010n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 1000 may include a plurality of computing devices (e.g., distributed computer systems) to implement various processing functions.

I/O device interface 1030 may provide an interface for connection of one or more I/O devices 1060 to computer system 1000. I/O devices may include devices that receive input (e.g., from a user) or output information (e.g., to a user). I/O devices 1060 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface may 1040 may facilitate data exchange between computer system 1000 and other devices connected to the network. Network interface 1040 may support wired or wireless communication. The network may include an electronic communication network, such as the Internet, a local area network (LAN), a wide area network (WAN), a cellular communications network, or the like.

System memory 1020 may be configured to store program instructions 1100 or data 1110. Program instructions 1100 may be executable by a processor (e.g., one or more of processors 1010a-1010n) to implement one or more embodiments of the present techniques. Instructions 1100 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium that may have program instructions stored thereon that are executable by a computer processor (e.g., one or more of processors 1010a-1010n) to cause the subject matter and the functional operations described herein. A memory (e.g., system memory 1020) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times, e.g., a copy may be created by writing program code to a first-in-first-out buffer in a network interface, where some of the instructions are pushed out of the buffer before other portions of the instructions are written to the buffer, with all of the instructions residing in memory on the buffer, just not all at the same time.

I/O interface 1050 may be configured to coordinate I/O traffic between processors 1010a-1010n, system memory 1020, network interface 1040, I/O devices 1060, and/or other peripheral devices. I/O interface 1050 may perform protocol, timing, or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000 or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices or software that may perform or otherwise provide for the performance of the techniques described herein. For example, computer system 1000 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) is said to be supplied or otherwise provided, the information may provided by sending instructions to retrieve that information from a content delivery network.

The reader should appreciate that the present application describes several independently useful techniques. Rather than separating those techniques into multiple isolated patent applications, applicants have grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to costs constraints, some techniques disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X'ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device.

In this patent, to the extent certain U.S. patents, U.S. patent applications, or other materials (e.g., articles) have been incorporated by reference. The text of such U.S. patents, U.S. patent applications, and other materials is, however, only incorporated by reference to the extent that no conflict exists between such material and the statements and drawings set forth herein. In the event of such conflict, the text of the present document governs.

The present techniques will be better understood with reference to the following enumerated embodiments:

1. A method of inferring which software-issue reports are addressed by a code-change submission, the method comprising: obtaining, with one or more processors, a plurality of software-issue reports, each software-issue report having a respective description of a requested change to a software application; after obtaining the plurality of software-issue reports, obtaining, with one or more processors, a current code-change submitted to a repository of source code of the software application; selecting, with one or more processors, a subset of the software-issue reports by inferring which of the software-issue reports describe an issue addressed by the current code-change, wherein selecting the subset of the software-issue reports comprises: extracting code-change features of the current code-change submitted to the repository, applying the code-change features to a model trained on a training set including labeled training records, each labeled training record including features of a previous code-change and a software-issue report addressed by the previous code-change, determining scores with the model indicative of likelihoods that corresponding respective software-issue reports describe an issue addressed by the current code-change, and selecting the subset of the software-issue reports based on the scores; and storing, with one or more processors, in memory an association between the subset of the software-issue reports and the current code-change.
2. The method of embodiment 1, comprising: causing the subset of the software-issue reports to be presented in a user-interface configured to receive one or more user selections among the subset of software-issue reports to identify software-issue reports addressed by the current code-change; receiving one or more user selections among the subset of software-issue reports entered via the user-interface; designating, in memory, software-issue reports corresponding to the one or more user selections as matching the current code-change; an retraining the model trained based on the one or more user selections.
3. The method of embodiment 2, comprising: before causing the subset of the software-issue reports to be presented in the user-interface, ranking the subset of the software-issue reports based on the scores, wherein: causing the subset of the software-issue reports to be presented comprises causing the subset of the software-issue reports to be presented in ranked order, the subset of the software-issue reports includes more than 2 and less than 20 software-issue reports, and selecting the subset of the software-issue reports based on the scores comprises selecting software issue reports both satisfying a threshold score and satisfying a threshold rank.
4. The method of any one of embodiments 1-3, wherein the plurality of software-issue reports are obtained from a version control system or a project management system; the current code-change is automatically obtained upon submission to the version control system or the project management system.
5. The method of any one of embodiments 1-4, comprising: before obtaining the current code-change, training the model, at least in part, by: obtaining the training set including the labeled training records; grouping the labeled training records by respective code segments of the source code of the software application to which respective previous code-changes in respective labeled training records apply to form a plurality of code-segment groups of labeled training records, at least some of the code-segment groups having a plurality of the labeled training records; and for each of the code-segment groups, training a code-segment-specific model based on the labeled training records in respective code-segment groups, wherein: extracting code-change features of the current code-change comprises ascertaining a code-segment to which the current code-change is made, and selecting the subset of the software-issue reports comprises accessing the code-segment-specific model corresponding to the code-segment to which the current code-change is made.
6. The method of embodiment 5, wherein: training the model comprises: for each of the code-segment groups, forming feature vectors based on n-grams appearing in respective software-issue reports in respective labeled training records in the code-segment groups of labeled training records; and selecting the subset of the software-issue reports comprises: determining feature vectors of the plurality of software-issue reports based on n-grams appearing in respective descriptions of respective requested changes; determining distances between respective feature vectors of the plurality of software-issue reports and a feature vector of the code-segment-specific model corresponding to the code-segment to which the current code-change is made; and determining the scores based on the distances.
7. The method of embodiment 6, wherein: determining the feature vectors of the plurality of software-issue reports occurs before obtaining the current code-change; the feature vector of the code-segment-specific model and the feature vectors of the plurality of software-issue reports have a plurality of values corresponding to different n-grams, the plurality of values being term-frequency inverse document frequency scores for the different n-grams; and determining the scores based on the distances comprises determining cosine similarities between respective feature vectors of the plurality of software-issue reports and the feature vector of the code-segment-specific model corresponding to the code-segment to which the current code-change is made.
8. The method of any one of embodiments 1-7, comprising: training the model, at least in part, by: obtaining the training set including the labeled training records; for each of the labeled training records, forming a previous code-change feature vector and a previous software-issue report feature vector based on n-grams appearing in previous code-changes and the software-issue reports addressed by the previous code-changes, respectively; and for the plurality of software-issue reports, forming current software-issue report feature vectors based on n-grams appearing in the respective description of the requested change; wherein: extracting code-change features of the current code-change comprises forming a current code-change feature vector based on n-grams appearing in the current code-change, and applying the code-change features to the model comprises selecting a subset of the labeled training records based on distances between the current code-change feature vector and respective previous code-change feature vectors, and determining scores with the model comprises determining distances between previous software-issue report feature vectors of the subset of the labeled training records and the current software-issue report feature vectors.
9. The method of embodiment 8, wherein: determining distances comprises determining cosine similarities, Minkowski distances, or Euclidian distances between feature vectors.
10. The method of any one of embodiments 1-9, wherein: extracting code-change features of the current code-change comprises: ascertaining a module of the source code of the software application changed by the current code-change; and traversing a call graph of the software application from the module to ascertain other modules that call the module; determining the scores comprises comparing n-grams in comments of source code of the module and the other modules to n-grams in the plurality of software-issue reports.
11. The method of embodiment 10, wherein: comparing n-grams comprises matching based on Latent Semantic Analysis.
12. The method of embodiment 10, wherein: comparing n-grams comprises matching based on Latent Dirichlet Allocation.
13. The method of any one of embodiments 1-12, wherein: obtaining the plurality of software-issue reports comprises obtaining more than 10,000 software-issue reports; and selecting the subset of the software-issue reports is performed within five seconds of obtaining the current code-change submitted to the repository of source code of the software application.
14. The method of any one of embodiments 1-13, wherein determining scores with the model indicative of likelihoods that corresponding respective software-issue reports describe the issue addressed by the current code-change comprises:
15. The method of any one of embodiments 1-14, comprising: providing a project management computer system; and updating a status of at least one of the subset of the software-issue reports in the project management computer system.
16. A tangible, non-transitory, machine-readable medium storing instructions that when executed by a data processing apparatus cause the data processing apparatus to perform operations comprising: the operations of any one of embodiments 1-15.
17. A system, comprising: one or more processors; and memory storing instructions that when executed by the processors cause the processors to effectuate operations comprising: the operations of any one of embodiments 1-15.

What is claimed is:

1. A method of inferring which software-issue reports are addressed by a code-change submission, the method comprising:
obtaining, with one or more processors, a plurality of software-issue reports, each software-issue report having a respective description of a requested change to a software application;
after obtaining the plurality of software-issue reports, obtaining, with one or more processors, a current code-change submitted to a repository of source code of the software application;
selecting, with one or more processors, a subset of the software-issue reports by inferring which of the software-issue reports describe an issue addressed by the current code-change, wherein selecting the subset of the software-issue reports comprises:
extracting code-change features of the current code-change submitted to the repository,
applying the code-change features to a model trained on a training set including labeled training records, each labeled training record including features of a previous code-change and a software-issue report addressed by the previous code-change,
determining scores with the model indicative of likelihoods that corresponding respective software-issue reports describe an issue addressed by the current code-change, and
selecting the subset of the software-issue reports based on the scores; and
storing, with one or more processors, in memory an association between the subset of the software-issue reports and the current code-change.

2. The method of claim 1, comprising:
causing the subset of the software-issue reports to be presented in a user-interface configured to receive one or more user selections among the subset of software-issue reports to identify software-issue reports addressed by the current code-change;
receiving one or more user selections among the subset of software-issue reports entered via the user-interface;
designating, in memory, software-issue reports corresponding to the one or more user selections as matching the current code-change; and
retraining the model trained based on the one or more user selections.

3. The method of claim 2, comprising:
before causing the subset of the software-issue reports to be presented in the user-interface, ranking the subset of the software-issue reports based on the scores, wherein:
causing the subset of the software-issue reports to be presented comprises causing the subset of the software-issue reports to be presented in ranked order,
the subset of the software-issue reports includes more than 2 and less than 20 software-issue reports, and
selecting the subset of the software-issue reports based on the scores comprises selecting software issue reports both satisfying a threshold score and satisfying a threshold rank.

4. The method of claim 1, wherein:
the plurality of software-issue reports are obtained from a version control system or a project management system; and
the current code-change is automatically obtained upon submission to the version control system or the project management system.

5. The method of claim 1, comprising:
before obtaining the current code-change, training the model, at least in part, by:
obtaining the training set including the labeled training records;
grouping the labeled training records by respective code segments of the source code of the software application to which respective previous code-changes in respective labeled training records apply to form a plurality of code-segment groups of labeled training records, at least some of the code-segment groups having a plurality of the labeled training records; and
for each of the code-segment groups, training a code-segment-specific model based on the labeled training records in respective code-segment groups,
wherein:
extracting code-change features of the current code-change comprises ascertaining a code-segment to which the current code-change is made,
selecting the subset of the software-issue reports comprises accessing the code-segment-specific model corresponding to the code-segment to which the current code-change is made.

6. The method of claim 5, wherein:
training the model comprises:
for each of the code-segment groups, forming feature vectors based on n-grams appearing in respective software-issue reports in respective labeled training records in the code-segment groups of labeled training records; and
selecting the subset of the software-issue reports comprises:
determining feature vectors of the plurality of software-issue reports based on n-grams appearing in respective descriptions of respective requested changes;
determining distances between respective feature vectors of the plurality of software-issue reports and a feature vector of the code-segment-specific model corresponding to the code-segment to which the current code-change is made; and
determining the scores based on the distances.

7. The method of claim 6, wherein:
determining the feature vectors of the plurality of software-issue reports occurs before obtaining the current code-change;
the feature vector of the code-segment-specific model and the feature vectors of the plurality of software-issue reports have a plurality of values corresponding to different n-grams, the plurality of values being term-frequency inverse document frequency scores for the different n-grams; and
determining the scores based on the distances comprises determining cosine similarities between respective feature vectors of the plurality of software-issue reports and the feature vector of the code-segment-specific model corresponding to the code-segment to which the current code-change is made.

8. The method of claim 1, comprising:
training the model, at least in part, by:
obtaining the training set including the labeled training records;
for each of the labeled training records, forming a previous code-change feature vector and a previous software-issue report feature vector based on n-grams appearing in previous code-changes and the software-issue reports addressed by the previous code-changes, respectively; and
for the plurality of software-issue reports, forming current software-issue report feature vectors based on n-grams appearing in the respective description of the requested change;
wherein:
extracting code-change features of the current code-change comprises forming a current code-change feature vector based on n-grams appearing in the current code-change, and
applying the code-change features to the model comprises selecting a subset of the labeled training records based on distances between the current code-change feature vector and respective previous code-change feature vectors, and
determining scores with the model comprises determining distances between previous software-issue report feature vectors of the subset of the labeled training records and the current software-issue report feature vectors.

9. The method of claim 8, wherein:
determining distances comprises determining cosine similarities, Minkowski distances, or Euclidian distances between feature vectors.

10. The method of claim 1, wherein:
extracting code-change features of the current code-change comprises:
ascertaining a module of the source code of the software application changed by the current code-change; and
traversing a call graph of the software application from the module to ascertain other modules that call the module;
determining the scores comprises comparing n-grams in comments of source code of the module and the other modules to n-grams in the plurality of software-issue reports.

11. The method of claim 10, wherein:
comparing n-grams comprises matching based on Latent Semantic Analysis.

12. The method of claim 10, wherein:
comparing n-grams comprises matching based on Latent Dirichlet Allocation.

13. The method of claim 1, wherein:
obtaining the plurality of software-issue reports comprises obtaining more than 10,000 software-issue reports; and
selecting the subset of the software-issue reports is performed within five seconds of obtaining the current code-change submitted to the repository of source code of the software application.

14. The method of claim, wherein determining scores with the model indicative of likelihoods that corresponding respective software-issue reports describe the issue addressed by the current code-change comprises:
steps for determining scores indicative of likelihoods that software-issue reports describe an issue addressed by a code-change.

15. The method of claim 1, comprising:
training the model with steps for training a model.

16. The method of claim 1, comprising:
providing a project management computer system;
updating a status of at least one of the subset of the software-issue reports in the project management computer system.

17. A tangible, non-transitory, machine-readable medium storing instructions that when executed by one or more computers effectuate operations comprising:
obtaining, with one or more processors, a plurality of software-issue reports, each software-issue report having a respective description of a requested change to a software application;
after obtaining the plurality of software-issue reports, obtaining, with one or more processors, a current code-change submitted to a repository of source code of the software application;
selecting, with one or more processors, a subset of the software-issue reports by inferring which of the software-issue reports describe an issue addressed by the current code-change, wherein selecting the subset of the software-issue reports comprises:
extracting code-change features of the current code-change submitted to the repository,
applying the code-change features to a model trained on a training set including labeled training records, each labeled training record including features of a previous code-change and a software-issue report addressed by the previous code-change,
determining scores with the model indicative of likelihoods that corresponding respective software-issue reports describe an issue addressed by the current code-change, and
selecting the subset of the software-issue reports based on the scores; and
storing, with one or more processors, in memory an association between the subset of the software-issue reports and the current code-change.

18. The medium of claim 17, the operations comprising:
causing the subset of the software-issue reports to be presented in a user-interface configured to receive one or more user selections among the subset of software-issue reports to identify software-issue reports addressed by the current code-change;
receiving one or more user selections among the subset of software-issue reports entered via the user-interface;
designating, in memory, software-issue reports corresponding to the one or more user selections as matching the current code-change; and
retraining the model trained based on the one or more user selections.

19. The medium of claim 17, wherein:
the plurality of software-issue reports are obtained from a version control system or a project management system;
the current code-change is automatically obtained upon submission to the version control system or the project management system; and
the operations comprise:
providing a project management computer system; and
updating a status of at least one of the subset of the software-issue reports in the project management computer system.

20. The medium of claim 17, the operations comprising:
before obtaining the current code-change, training the model, at least in part, by:
obtaining the training set including the labeled training records;
grouping the labeled training records by respective code segments of the source code of the software application to which respective previous code-changes in respective labeled training records apply to form a plurality of code-segment groups of labeled training records, at least some of the code-segment groups having a plurality of the labeled training records.
